(19) United States
(12) Patent Application Publication
(10) Pub. No.: US 2009/0207905 A1
(43) Pub. Date: Aug. 20, 2009

(54) COMMUNICATION PROCESSING DEVICE, DATA COMMUNICATION SYSTEM, METHOD, AND COMPUTER PROGRAM

(75) Inventor: Nobuyoshi Tomita, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Minato-ku, Tokyo (JP)

(21) Appl. No.: 12/303,122

(22) PCT Filed: Aug. 1, 2007
(86) PCT No.: PCT/JP07/65097

§ 371 Date: Dec. 2, 2008

(51) Int. Cl. H04N 11/02; G06F 17/30

(52) U.S. Cl. 375/240.01; 726/4; 375/E07.001

(57) ABSTRACT

An apparatus and a method for realizing a configuration for transmitting and outputting captured data of a video camera to a specific device via a network are provided. In a configuration for generating a transmission packet containing the captured data of the video camera and outputting the transmission packet via a network, a host name of a data transmission destination device and a port number, to which port forwarding processing of a relay device of a network connected to the data transmission destination device is set, are acquired from a memory, address information corresponding to the host name is acquired from a DNS server, and a captured image data containing transmission packet in which the address information and the port number are set as destination information is output via the network. This configuration permits data to be certainly transmitted to a specific selected device and reproduction of stream data in synchronization with a capturing timing is realized.

### TECHNICAL FIELD

The present invention relates to communication processing apparatuses, data communication systems, and methods as well as computer programs. More particularly, the present invention relates to a communication processing apparatus allowing a specific receiving apparatus at a remote place to receive and reproduce, via a network such as the Internet, captured data acquired in an image capturing apparatus, such as, for example, a video camera, a data communication system, and a method as well as a computer program.

### BACKGROUND ART

Recently, the use of video cameras is widespread and many users perform capturing utilizing the video cameras. Data captured by the video cameras is recorded on recording media, such as, for example, an HD (Hard Disk) and a DVD (Digital Versatile Disc), installed in the video cameras. When reproduction is performed, processing for outputting and reproducing the data recorded on these recording media after connecting the video cameras to a reproducing apparatus, such as, for example, a TV, with a cable is common.

However, there is a case where captured live video is desired to be shown to people at a remote place, for example, as in a case of going on a trip or going to an amusement park and performing video capturing and a case of participating in a party or the like and performing various kinds of capturing using a video camera.

As conventional methods for performing processing for transferring such captured video, there is a method as follows:

(a) Processing on a capturing user side: to upload captured data to a specific server via the Internet utilizing a communication interface of a video camera; and

(b) Processing on a viewing user side (client): to establish a connection to a server, to which the captured data is uploaded, utilizing a communication interface of, for example, a PC, acquire the data via the Internet, and output and view the data on a display of the PC.

As described above, when reproduction of captured data is attempted at a remote place, processing for acquiring the uploaded data on the client side after execution of processing for temporarily uploading the captured data to a server is required.

Nevertheless, in such a method, a considerable amount of lag (delay) is caused between a timing of capturing and a timing of viewing and viewing of live video is not realized. Accordingly, for example, it becomes difficult to perform interactive communication regarding captured images between a capturing person side and a viewing person side. For example, in an environment having a lag between the captured images and the viewed images in this manner, there is a problem that communication, such as the capturing person side's offering an explanation of captured images to the viewing person side and the viewing person side's making a request for captured images to the capturing person, does not work well.

Additionally, when processing for uploading captured data to a specific server and acquiring the data from the server on the client side is performed, a contract for accessing the server with a provider is necessary and a complex setting is required. There is also a problem that users not having such a contract with the server cannot utilize.

Meanwhile, as conventional techniques disclosing a technology for distributing moving images from video cameras, there are Japanese Unexamined Patent Application Publication No. 2006-13739 (Patent Document 1), Japanese Unexamined Patent Application Publication No. 2005-101980 (Patent Document 2), or the like, for example. However, neither of them is configured to be able to output realtime video on a home TV directly from a video camera via the Internet or perform interactive communication.

Meanwhile, a configuration for outputting video of, for example, a web camera or the like disposed at a fixed place with a home PC or the like via the Internet is also realized. However, this processing requires processing for inputting a URL of a device to which the web camera is connected on a PC side and accessing the Internet from the PC side.

Such a web camera for use in video distribution is granted with a specific global IP address and is configured to permit anyone to access thereto. However, a global IP address often is not set for video cameras utilized by general personal users. Thus, when streaming is carried out from a video camera to a home TV via a home or public wireless LAN, the video camera's registering an IP address in a DNS server and the video camera's controlling port forwarding of a router are needed. Nevertheless, it may be difficult to adopt such functions because of restrictions regarding a processing capability and a memory capacity of the video camera.

Additionally, in general, since video captured with a personal user's video camera is generally private and is not to be opened to an unspecified large number of people unlike that of the web camera, it is not preferable, from the view point of protection of personal information, to permit anyone to access the video through specification of an address. Accordingly, a configuration for selecting a transmission target by a capturing person side on the video camera side and transmitting captured images to the specific selected client is preferable.

Although the video camera side has to learn a URL (IP address) of data reproducing means (e.g., a TV) on a connection target side to transmit the captured data to the specific selected client, such a method is not disclosed by conventional techniques.

### Patent Document 1: Japanese Unexamined Patent Application Publication No. 2006-13739

### Patent Document 2: Japanese Unexamined Patent Application Publication No. 2005-101980

### DISCLOSURE OF INVENTION

### Technical Problem

The present invention is made in view of the above-described circumstance, and aims to provide a communication processing apparatus that permits reproduction of a stream by transmitting captured data to a remote place, and further permits transmission of captured data only to a specific selected client by selecting a data transmission target on a video camera side that acquires the captured data, a data communication system, and a method as well as a computer program.

### Technical Solution

A first aspect of the present invention is a communication processing apparatus having a video camera function, and the communication processing apparatus is characterized by including:

a communication controlling unit that executes processing for generating a transmission packet containing data captured with the video camera function and for outputting the transmission packet to a network; and

a memory that stores a host name of a data transmission destination device and a port number to which port forwarding processing, of a relay device of a network connected to the data transmission destination device, for transferring the transmission packet to the data transmission destination device is set, wherein

the communication controlling unit

is configured to execute the processing for generating the transmission packet including, as destination information, the port number and address information corresponding to the host name of the data transmission destination device and for outputting the transmission packet to the network.

Furthermore, in one embodiment of the communication processing apparatus of the present invention, the communication processing apparatus is characterized in that the communication controlling unit is configured to receive the address information corresponding to the host name of the data transmission destination device stored in the memory from a DNS server, and to execute the processing for generating the transmission packet including, as the destination information, the received address and for outputting the transmission packet to the network.

Furthermore, in one embodiment of the communication processing apparatus of the present invention, the communication processing apparatus is characterized by including an authentication processing unit that executes authentication processing with the data transmission destination device, and it is configured that processing for receiving, on condition of establishment of authentication in the authentication processing unit, the host name of the data transmission destination device and the port number, to which the port forwarding processing of the relay device of the network connected to the data transmission destination device is set, from the data transmission destination device and for storing the host name and the port number in the memory is executed.

Furthermore, in one embodiment of the communication processing apparatus of the present invention, the communication processing apparatus is characterized by further including: a decoder that executes decoding processing of image and audio data included in reception data of the communication controlling unit; and a data combining unit that performs control for combining data generated by the decoder with the data captured with the video camera function.

Furthermore, a second aspect of the present invention is

a communication processing apparatus that executes output control of data received via a network, and

the communication processing apparatus is characterized by including:

a communication controlling unit that executes a request for setting port forwarding processing, which is processing for transferring packets to the communication processing apparatus, to a relay device of a network connected to the communication processing apparatus, and receives data via the network and the relay device;

a decoding processing unit that executes decoding processing of the data received at the communication processing unit; and

an output processing unit that executes processing for outputting data generated in the decoding processing unit.

Furthermore, in one embodiment of the communication processing apparatus of the present invention, the communication processing apparatus is characterized by further including: a camera unit; and a data combining unit that performs control for combining the data received at the communication controlling unit with data captured in the camera.

Furthermore, in one embodiment of the communication processing apparatus of the present invention, the communication processing apparatus is characterized in that the communication controlling unit is configured to execute processing for generating a packet containing data captured in the camera and for outputting the packet to the network.

Furthermore, in one embodiment of the communication processing apparatus of the present invention, the communication processing apparatus is characterized in that the communication controlling unit is configured to perform execution and termination of transmission of the packet containing the data captured in the camera on the basis of input information input through a user input unit.

Furthermore, in one embodiment of the communication processing apparatus of the present invention, the communication processing apparatus is characterized by including: a data combining unit that displays and outputs bit rate information of the data received at the communication controlling unit.

Furthermore, in one embodiment of the communication processing apparatus of the present invention, the communication processing apparatus is characterized in that the communication controlling unit is configured to execute processing for outputting a bit rate setting request to a transmission source of the data received via the network on the basis of bit rate setting information input through a user input unit.

Moreover, a third aspect of the present invention is

a data communication system including: data transmitting means having a video camera function; and data receiving means for receiving transmission data of the data transmitting means, and the data communication system is characterized in that

the data transmitting means includes:

a communication controlling unit that executes processing for generating a transmission packet containing data captured with the video camera function and for outputting the transmission packet to a network; and

a memory that stores a host name of the data receiving means and a port number to which port forwarding processing, of a relay device of a network connected to the data receiving means, for transferring the transmission packet to the data receiving means is set, and wherein

the communication controlling unit

is configured to execute the processing for generating the transmission packet including, as destination information, the port number and address information corresponding to the host name of the data receiving means and for outputting the transmission packet to the network, and wherein

the data receiving means includes:

a communication controlling unit that executes a request for setting the port forwarding processing to the relay device of the network connected to the data receiving means and receives data from the data transmitting means via the network and the relay device;

a decoding processing unit that executes decoding processing of the data received at the communication controlling unit from the data transmitting means; and

an output processing unit that executes output processing of data generated in the decoding processing unit.

Furthermore, a fourth aspect of the present invention is

a communication controlling method in a communication processing apparatus having a video camera function, and

the communication controlling method is characterized by including:

a step of a communication controlling unit's acquiring, from a memory, a host name of a data transmission destination device and a port number to which port forwarding processing, which is processing for transferring packets to the data transmission destination device, of a relay device of a network connected to the data transmission destination device is set;

a step of the communication controlling unit's receiving address information corresponding to the host name of the data transmission destination device from a DNS server; and

a step of the communication controlling unit's executing processing for generating a transmission packet that includes, as destination information, the port number and the address information corresponding to the host name of the data transmission destination device and that contains data captured with a video camera and for outputting the transmission packet to a network.

Furthermore, a fifth aspect of the present invention is

a data processing method for executing control of data received via a network in a communication processing apparatus, and

the data processing method is characterized by including:

a step of a communication controlling unit's executing a request for setting port forwarding processing, serving as processing for transferring packets to the communication processing apparatus, to a relay device of a network connected to the communication processing apparatus;

a step of the communication controlling unit's receiving data via the network and the relay device;

a decoding processing step of a decoding processing unit's executing decoding processing of the data received at the communication controlling unit; and

an output processing step of an output processing unit's executing output processing of data generated in the decoding processing unit.

Moreover, a sixth aspect of the present invention is

a computer program allowing a communication processing apparatus having a video camera function to execute communication control, and

the computer program is characterized by including:

a step of allowing a communication controlling unit to acquire, from a memory, a host name of a data transmission destination device and a port number to which port forwarding processing, which is processing for transferring packets to the data transmission destination device, of a relay device of a network connected to the data transmission destination device is set;

a step of allowing the communication controlling unit to receive address information corresponding to the host name of the data transmission destination device from a DNS server; and

a step of allowing the communication controlling unit to execute processing for generating a transmission packet that includes, as destination information, the port number and the address information corresponding to the host name of the data transmission destination device and that contains data captured with a video camera and for outputting the transmission packet to a network.

Furthermore, a seventh aspect of the present invention is

a computer program for allowing a communication processing apparatus to control data received via a network, and

the computer program is characterized by including:

a step of allowing a communication controlling unit to execute a request for setting port forwarding processing, serving as processing for transferring packets to the communication processing apparatus, to a relay device of a network connected to the communication processing apparatus;

a step of allowing the communication controlling unit to receive data via the network and the relay device;

a decoding processing step of allowing a decoding processing unit to execute decoding processing of the data received at the communication controlling unit; and

an output processing step of allowing an output processing unit to execute output processing of data generated in the decoding processing unit.

Meanwhile, the computer programs of the present invention are computer programs providable through, for example, storage media or communication media providing programs to general-purpose computer systems capable of executing various program codes in a computer readable format, e.g., storage media such as a CD, an FD, and an MO or communication media such as a network. By providing such programs in a computer readable format, processing corresponding to the programs is realized on the computer system.

Still other objects, features, and advantages of the present invention will become apparent from a more detailed description based on embodiments of the present invention to be described later and the accompanying drawings. In addition, in this specification, a system is a configuration of a logical collection of a plurality of apparatuses and is not limited to one including apparatuses of respective configurations in an identical housing.

### ADVANTAGEOUS EFFECTS

According to a configuration of one embodiment of the present invention, for example, in a configuration for generating a transmission packet containing captured data of a video camera and outputting the transmission packet to a network, it is configured that a host name of a data transmission destination device and a port number, to which port forwarding processing of a relay device of a network connected to the data transmission destination device is set, are acquired from a memory, address information corresponding to the host name of the data transmission destination device is acquired from a DNS server, and a transmission packet containing data captured in a video camera is output to a network after the address information and the port number are set in the transmission packet as destination information. This permits data to be certainly transmitted to a specific selected device and reproduction of stream data, serving as reproduction of data in synchronization with a timing of capturing, is realized.

### BRIEF DESCRIPTION OF DRAWINGS

FIG. 1 is a diagram showing an example of a system configuration according to one embodiment of the present invention.

FIG. 2 is a diagram showing an example of a system configuration in which a home A 120 shown in FIG. 1 is replaced by a public wireless LAN (hotspot) 126.

FIG. 3 is a diagram describing an example of display data displayed on a display screen of output means.

FIG. 4 is a diagram describing an IP packet transmission/reception sequence from a video camera to a reception box.

FIG. 5 is a diagram describing a configuration for interactive communication.

FIG. 6 is a diagram describing an example of displaying not only video/audio from a video camera but also input video of a reception box at the same time.

FIG. 7 is a diagram describing an example of a configuration of processing for reproducing received data in a video camera.

FIG. 8 is a diagram describing a detail of processing of a video camera for learning an IP address of a router.

FIG. 9 is a diagram describing a port forwarding setting processing of a router for transferring an IP packet to a reception box.

FIG. 10 is a diagram showing a flowchart describing a flow of entire processing of setting processing for performing communication of the present invention and communication execution processing.

FIG. 11 is a diagram describing an example of a configuration of a video camera serving as one example of a data transmitting device.

FIG. 12 is a diagram describing an example of a configuration of a reception box serving as one example of a data receiving device.

FIG. 13 is a diagram showing an example of a table of a host name and a port number.

### BEST MODES FOR CARRYING OUT THE INVENTION

Details of a communication processing apparatus, a data communication system, and a method as well as a computer program of the present invention will be described below with reference to the drawings. The present invention is to permit data captured by a video camera to be directly displayed on a reproducing apparatus (e.g., a TV) located at a remote place via a network, like a live broadcast. Meanwhile, although a description will be given while considering data transmitted from a video camera to a reproducing apparatus is data being captured by the video camera in the following embodiments, the data may be data being reproduced by the video camera. In addition, captured data of a video camera to be transferred via a network is also recorded on a recording medium (e.g., a DVD or an HD) or the like of the video camera. The description will be given in accordance with the following categories.

1. Example of System Configuration

2. Processing on Data Transmitting Side (Video Camera)

3. Processing on Data Receiving Side (Reception Box)

4. Processing of Router and Packet

### Transmission/Reception Processing

5. Stream Data Communication in Opposite Direction

6. Regarding Preceding Setting Processing

7. Overall Processing Flow

8. Example of Apparatus Configuration

### 1. Example of System Configuration

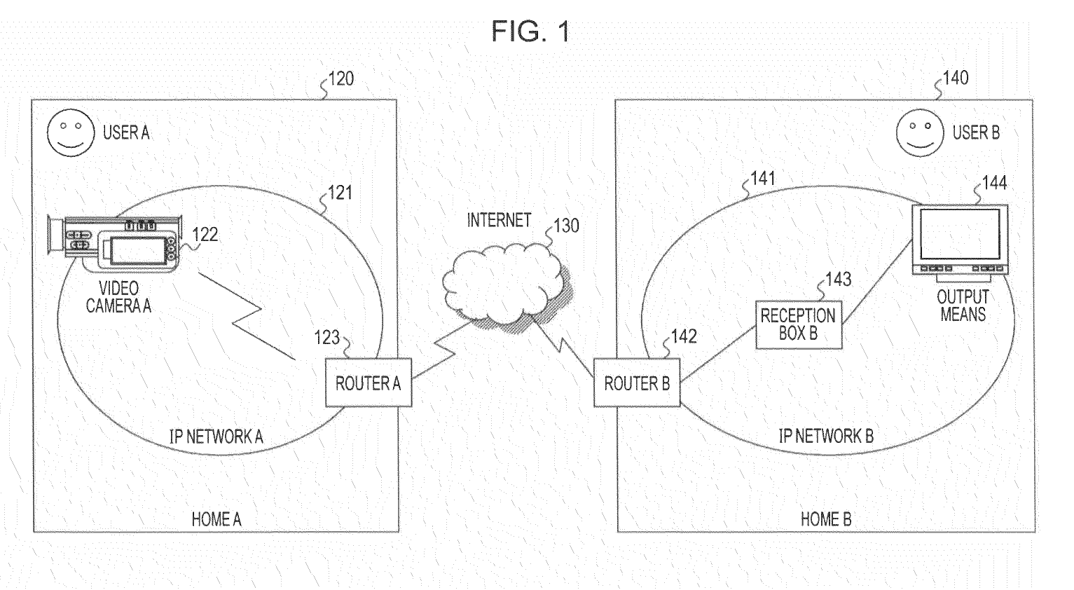

First, an example of a system configuration of a data communication system according to one embodiment of the present invention will be shown with reference to FIG. 1. This embodiment is a data communication system in which, as shown in FIG. 1, a user A performs capturing with a video camera A 122 at a given home A 120 and transfers the captured data to a home B 140 located at a remote place away from a home A, and the captured data is output on output means (e.g., a TV) 144 of the home B 140 and is viewed.

Although the example shown in the drawing illustrates an example configuration in which an IP network A 121 and an IP network B 141 serving as home networks are constructed at the home A 120 and the home B 140, respectively, and each of the home networks is connected via Internet 130, the IP network A 121 and the IP network B 141 only have to be network systems connectable to the Internet 130, such as, for example, a public wireless LAN (hotspot).

### 2. Processing on Data Transmitting Side (Video Camera)

In the IP network A 121 of the home A 120, the user A performs capturing using the digital video camera A 122. The video camera A 122 is configured as a device that performs, in parallel to capturing processing, stream transmission of video/audio contained in the captured data. More specifically, the video camera A 122 has a communication interface, and generates and outputs communication packets.

Additionally, the video camera A 122 can be set into various modes. For example, data to be transmitted to the home B via the Internet 130 corresponds to captured video/audio data (it does not matter whether the video/audio are simultaneously being recorded on a DV tape, an HDD/DVD, or the like) when the video camera A 122 is in a “capturing mode”, whereas the data corresponds to video/audio data being reproduced on a monitor of the video camera 122 when the video camera A 122 is in a “reproduction mode”.

The video camera A 122 has a communication interface (I/F) for connecting the video camera to IP (Internet Protocol) networks, such as, for example, a wireless LAN of IEEE 802.11g or the like and a wired LAN of Ethernet (registered trademark) or the like. Meanwhile, this communication interface does not have to be integrated into the video camera A 122 itself and may be an external module.

The video camera A 122 is connected to the IP network A 121, such as a home network, through the communication I/F. The video camera A 122 executes realtime streaming via this IP network A 121. More specifically, the video camera A includes an encoder that encodes (compression coding) video/audio being captured or reproduced in the video camera A 122 at a desired quality, includes a packet generating unit that packetizes the encoded data, and continuously sends out the generated packets to the IP network A 121.

Meanwhile, regarding a protocol on the IP network A 121, for example, a connection-type TCP (Transport Control Protocol) may be employed or a connectionless-type UDP (User Datagram Protocol) may be employed. The communication protocol is not limited particularly.

In addition, it may be difficult to send out video/audio to a network as they are at the same quality as that of video/audio actually recorded on a DV tape, an HDD/DVD, or the like because of a band of the network. For example, a case where the captured data is data having a large amount of data, like high-definition data or the like, corresponds to this case. In such a case, the video camera A 122 has a function for transmitting the data to the IP network A 121 after lowering a bit rate by executing encoding processing while lowering a quality (frame rate, resolution, image quality, sound quality, or the like) to reduce the amount of data.

A router A 123 serving as a network relay device is connected to the IP network A 121. Transmission data from the video camera A 122 is output to the Internet 130 through the router A 123. Meanwhile, a “destination IP address” serving as a transmission destination address has to be set in a data packet to be transmitted to the Internet A 130. This “destination IP address” is an address of a router B 142 serving as a network relay device of the home B 140. A detail of this address setting processing will be described at a later part.

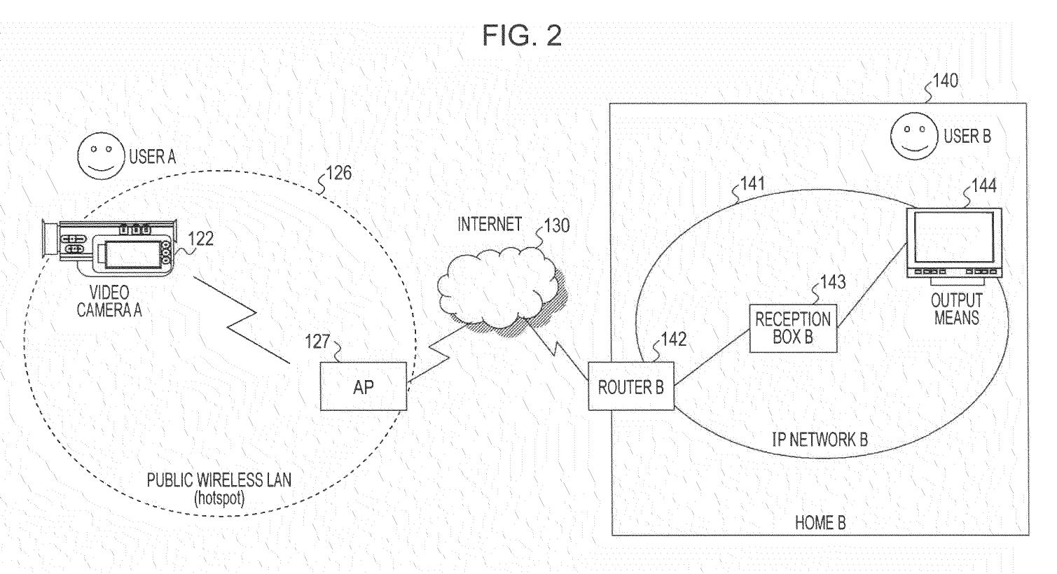

Meanwhile, although an example of a configuration where the IP network A 121 and the IP network B 141 serving as home networks are constructed at the home A 120 and the home B 140, respectively, and each of the home networks is connected via the Internet 130 is shown in the example illustrated in FIG. 1, the IP network A 121 and the IP network B 141 only have to be a network system, such as, for example, a public wireless LAN (hotspot), connectable to the Internet 130 as described before. FIG. 2 shows an example in which the home A 120 shown in FIG. 1 is replaced by a public wireless LAN (hotspot) 126. Empty transmission data to the video camera 122 is output to the Internet 130 through an AP (Access Point) 127 provided in the public wireless LAN (hotspot) 126.

### 3. Processing on Data Receiving Side (Reception Box)

Next, processing of a reception box B 143 on the home B 140 side for receiving data from the home A 120 via the Internet 130 and outputting the received data on output means 144 will be described. The reception box B 143 has a function of, for example, a so-called set top box (STB). The reception box B performs processing, such as communication control through communication with a data transmission source and output control of display data or the like on the output means 144, after executing data receiving processing via a network, analysis of the received data, and so forth.

The reception box B 143 is a device that receives video/audio streams transmitted from the video camera A 122. For example, the reception box B has a communication interface (I/F) for connecting the reception box to the IP network B 141, such as, for example, radio (wireless LAN) of IEEE 802.11g or the like and a wired LAN of Ethernet (registered trademark) or the like. Through this communication I/F, the reception box B is connected to the IP network B 141, such as a home network, and receives data through the router 142.

The reception box B 143 can receive a realtime stream from an external device (in this example, the video camera A 122) via the IP network B 141. More specifically, the reception box B performs processing for buffering data continuously received via the IP network B 141 for a while for the purpose of stable reproduction, decoding (decompression decoding) the received data, and outputting the received data on the output means 144 to display/reproduce the data. Accordingly, the reception box B 143 has a video/audio output unit for displaying/reproducing data on the output means 144, such as a TV.

Meanwhile, the reception box B 143 itself may be configured as the output means 144, such as, for example, a configuration where the reception box B 143 is included in the output means 144, such as, for example, a TV. With control of the reception box B 143, video and other data received from the video camera A 122 are displayed on a display screen of the output means 144.

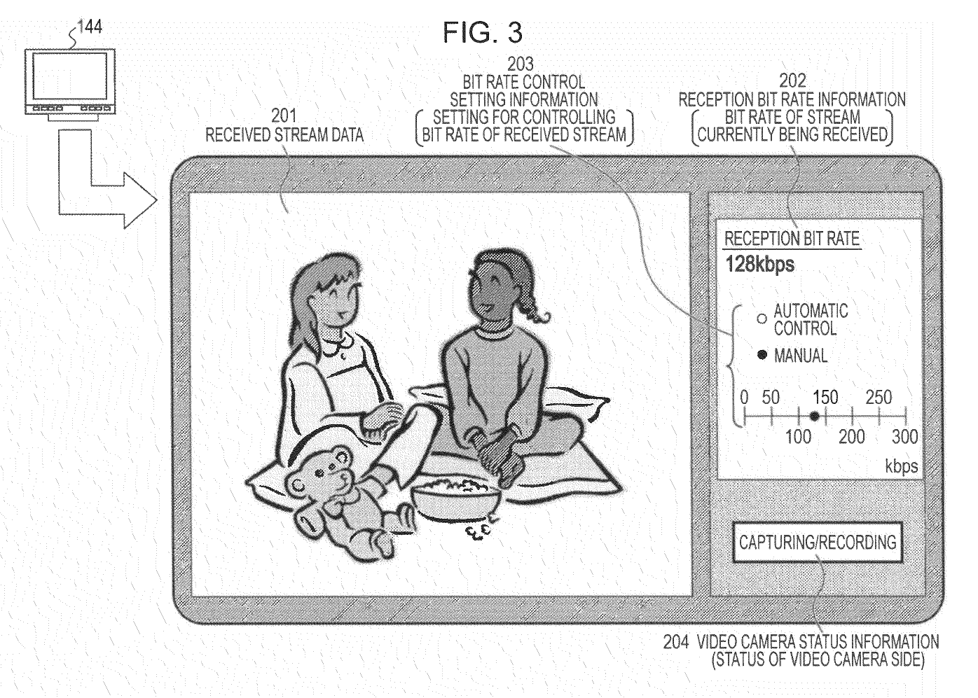

An example of display data displayed on a display screen of the output means 144 with control of the reception box B 143 will be described with reference to FIG. 3. As shown in FIG. 3, various information as well as received stream data 201 are displayed on the output means 144. A display screen of the output means 144 is set as a GUI (Graphical User Interface) capable of receiving input and control of users. For example, as shown in FIG. 3, reception bit rate information 202, bit rate control setting information 203, and video camera status information 204 are displayed. These kinds of information are information acquired by the reception box B 143.

The reception bit rate information 202 is a bit rate of a received stream. In the example shown in FIG. i, the reception bit rate information is displayed as 128 kbps, based on which the received stream data 201 being displayed can be recognized to be data being transmitted at a bit rate of 128 kbps.

The bit rate control setting information 203 is a setting part for performing a setting regarding whether to perform control of the bit rate “automatically” or “manually”. A user can select “automatic” or “manual”. When the “manual” is set, the user can set the bit rate between 0-300 kbps as shown in the drawing. When the “automatic” is set, the reception box B 143 adaptively changes the bit rate. When performing this bit rate control processing, it is configured that the reception box B 143 notifies the video camera A 122 serving as a data transmitting side device of requested bit rate information, for example, with a signaling message or the like and the video camera A 122 changes a transmission bit rate in accordance with the request.

In addition, the video camera status information 204 is video camera status information regarding a status of the video camera A 122, more specifically, which status, such as “capturing”, “capturing/recording”, or “reproducing”, the video camera A 122 is in. By performing displaying of this status, the user B side can learn whether the data output on the output means 144 is live video or video being captured and also being recorded.

Meanwhile, as processing for the display processing of this video camera status information 204, for example, the video camera A 122 notifies the reception box B 143 of a change in the status with a signaling message or the like every time the status changes or transmits stream data after setting a flag indicating the status thereof in the stream data itself. The reception box B 143 performs displaying of the video camera status information 204 based on an identification result after performing identification of the status information received as a message from the video camera A 122 or the flag.

### 4. Processing of Router and Packet Transmission/Reception Processing

Next, processing of the router A 123 and the router B 142 serving as network relay devices shown in FIG. 1 and communication packet transmission/reception processing via a network will be described. The IP network A 121 connected to the video camera A 122 and the IP network B 141 connected to the reception box B 143 are connected via the global IP network (hereinafter, referred as the Internet) 130, such as the Internet.

The router A 123 and the router B 142, such as broadband routers, are provided between the IP network A 121 and the Internet 130 and between the IP network B 141 and the Internet 130, respectively.

These routers generally provide a firewall function for filtering IP packets from the Internet and an NAT (Network Address Translator) function for converting a global IP address of the Internet into a private IP address of the home network.

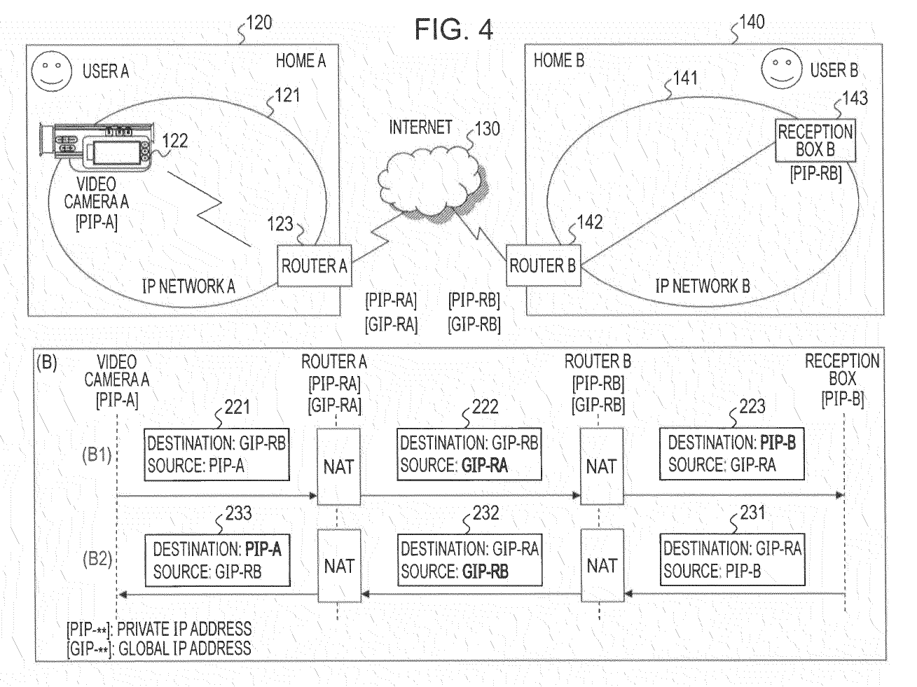

An IP packet transmission/reception sequence from the video camera A 122 to the reception box B 143 will be described below with reference to FIG. 4. FIG. 4 (B) shows changes in addresses of communication packets.

(B1) is regarding a transmission packet from the video camera A 122 to the reception box B 143, whereas

(B2) is regarding a transmission packet from the reception box B 143 to the video camera A 122, and

changes in addresses of these packets are shown, respectively. Meanwhile, in the drawings, a PIP represents a private IP address in the IP network A or the IP network B, whereas a GIP represents a global IP address.

First, a transmission packet from the video camera A 122 to the reception box B 143 shown in (B1) will be described. First, the video camera A 122 serving as a data transmitting side device generates a packet 221 in which

a “destination IP address” is set to a global IP address of the router B 142 and

a “transmission source IP address” is set to a private IP address of the video camera A 122, and

sends out the packet to the IP network A 121.

If the IP network A 121 is a network using private IP addresses, the router A 123 converts (NAT) the “transmission source IP address” of the IP packet sent out from the video camera A 122 to the IP network A 121 into a global IP address of the router A 123, generates a packet 222 in which

the “destination IP address” is set to the global IP address of the router B 142 and

the “transmission source IP address” is set to a global IP address of the router A 123, and

transfers the packet to the Internet 130.

Meanwhile, if the IP network A 121 is a network using global IP addresses, there is no need to perform the address conversion.

The IP packet transferred to the Internet 130 arrives at the router B 142 indicated by the “destination IP address”.

Next, the router B 142 performs packet transfer control based on the transmission source IP address or the like. For example, if a setting for transferring the IP packet is not made, the IP packet is discarded by the firewall function. If the setting for transferring the packet in the IP network B 141 is made, the router B performs transfer in accordance with the setting. At that time, if the IP network B is a network using private IP addresses, the router B 142 converts the “destination IP address” of the received packet into a private IP address of the reception box B 143 and transfers the packet to the IP network B 141. More specifically, the router B generates a packet 223 in which

the “destination IP address” is set to the private IP address of the reception box B 143 and

the “transmission source IP address” is set to the global IP address of the router A 123, and

outputs the packet to the IP network B 141.

This packet output to the IP network B 141 is delivered to the reception box B 143. Meanwhile, if the IP network B 141 is a network using global IP addresses, there is no need to perform the address conversion.

In addition, for example, in the case of a bit rate change request or the like, communication has to be performed from the reception box 143 to the video camera 232. A change in an address of a communication packet in this case will be described with reference to FIG. 4 (B2).

First, the reception box B 143 serving as a data transmitting side device generates a packet 231 in which

a “destination IP address” is set to a global IP address of the router A 123 and

a “transmission source IP address” is set to a private IP address of the reception box B 143, and

sends out the packet to the IP network B 141.

If the IP network B 141 is a network using private IP addresses, the router B 142 converts (NAT) the “transmission source IP address” of the IP packet sent out from the reception box B 143 to the IP network B 141 into a global IP address of the router B 142, generates a packet 232 in which

the “destination IP address” is set to the global IP address of the router A 123 and

the “transmission source IP address” is set to the global IP address of the router B 142, and

transfers the packet to the Internet 130.

Meanwhile, if the IP network B 141 is a network using global IP addresses, there is no need to perform the address conversion.

The IP packet transferred to the Internet 130 arrives at the router A 123 indicated by the “destination IP address”.

Next, the router A 123 performs packet transfer control based on the transmission source IP address or the like. For example, if a setting for transferring the IP packet is not made, the IP packet is discarded by the firewall function. If the setting for transferring the packet in the IP network A 121 is made, the router A performs transfer in accordance with the setting. At that time, if the IP network A 121 is a network using private IP addresses, the router A 123 converts the “destination IP address” of the received packet into a private IP address of the video camera 122 and transfers the packet to the IP network A 121. More specifically, the router A generates a packet 233 in which

the “destination IP address” is set to the private IP address of the video camera 122 and

the “transmission source IP address” is set to the global IP address of the router B 142, and

outputs the packets to the IP network A 121.

This packet output to the IP network A 121 is delivered to the video camera 122. Meanwhile, if the IP network A 121 is a network using global IP addresses, there is no need to perform the address conversion.

In this manner, the IP packet transmitted by the video camera A 122 is delivered to the reception box B 143, whereas the IP packet transmitted by the reception box B 143 is delivered to the video camera A 122. Meanwhile, in the above-described processing, at the time of the packet transmission from the video camera A 122 to the reception box B 143, these kinds of processing of

(a) the video camera A 122's learning an IP address of the router B 142 and

(b) the router B 142's making a setting for transferring an IP packet to the reception box B 143

are needed.

In addition, when data transmission is performed from the reception box B 143 to the video camera A 122, these kinds of processing of

(c) the reception box B 143's learning an IP address of the router A 123 and

(d) the router A 123's making a setting for transferring an IP packet to the video camera 122

are needed. These kinds of processing (a)-(d) will be described later.

### 5. Stream Data Communication in Opposite Direction

As described above, it is possible to directly display, like a live broadcast, data transmitted from the video camera A 122 on the output means 144, such as a TV, of the home B 140 at a remote place by continuously transferring IP packets from the video camera A 122 to the reception box B 143 to perform realtime streaming. In addition, by employing the packet communication route described in FIG. 4(b2), it is also possible to perform data transmission from the reception box B 143 to the video camera A 122.

The user A who is actually performing capturing or reproduction using the video camera A 122 may want to see a reaction of the user B viewing the video/audio on the output means 144 with control of the reception box B 143 or hear a comment thereabout. Conversely, the user B viewing the video/audio may also want to issue a request of video that the user B wants the user A to display or have a conversation regarding a detailed situation.

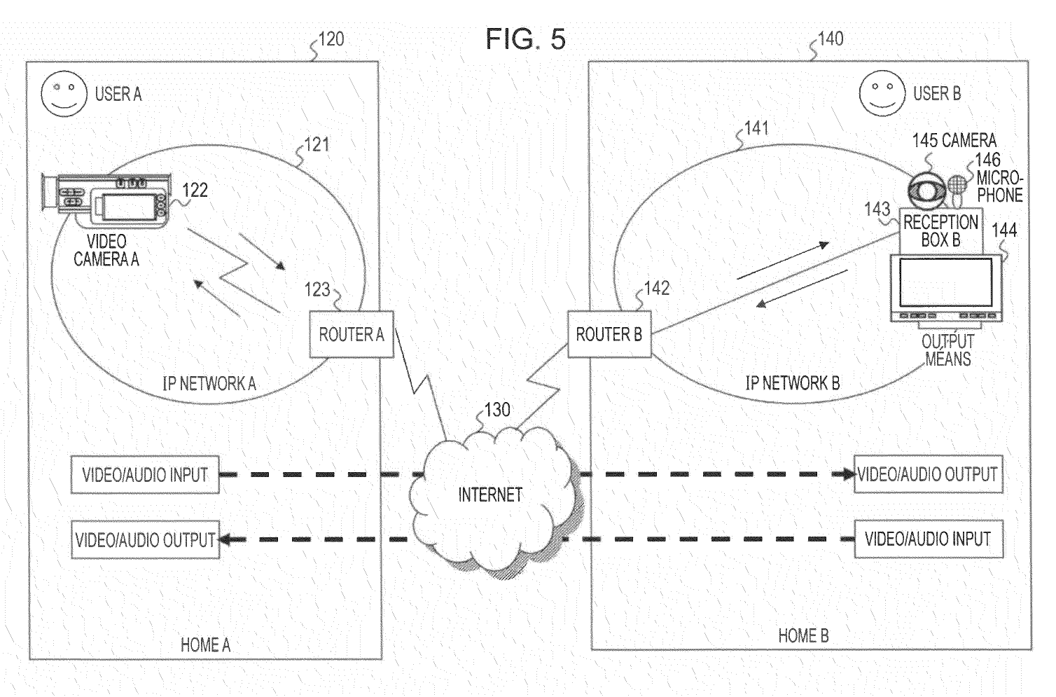

To permit such communication, the present invention also permits realtime streaming in the opposite direction. More specifically, the present invention is a configuration that permits interactive streaming communication. Setting of an address of a communication packet is carried out in the processing described with reference to FIGS. 4(B1) and (B2). Furthermore, this interactive communication configuration will be described with reference to FIG. 5.

The reception box B 143 on the home B 140 side receives video/audio streams to be received from the video camera A 122 of the home A 120. At the same time, the reception box B performs output of a realtime steam of input data of at least either video or audio on the home B 140 side input through a camera 145 and a microphone 146 attached to the reception box B 143 to the video camera A 122 by packet communication in a route opposite to the data reception route, namely, the packet communication described with reference to FIG. 4 (B2).

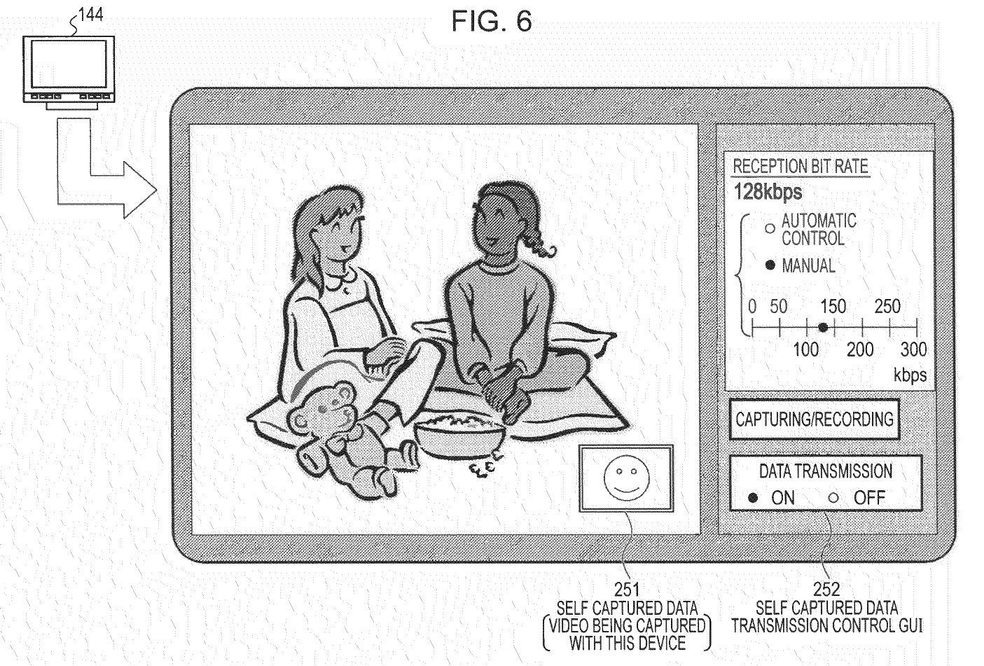

At this time, not only video/audio from the video camera A 122 but also input video of the reception box B 143 are simultaneously displayed on the output means 144 connected to the reception box B 143. For example, as shown in FIG. 6, self captured data 251 being captured with the camera 145 attached to the reception box 143 is simultaneously displayed in addition to display of images received from the video camera A 122.

Additionally, it is desirable to provide a GUI permitting audio/video from the reception box B 143 to the video camera A 122 to be turned ON/OFF in case the user B on the home B side temporarily does not want to transmit video or audio included in the self captured data 251 to the home A side (the video camera A 122). For example, a GUI, like self captured data transmission control GUI 252 shown in FIG. 6, is set.

On the other hand, the video camera A 122 transmits video/audio streams to the reception box B 143. At the same time, the video camera A can receive, as a realtime stream, video and audio captured with the camera 145 and the microphone 146 attached to the reception box B 143 and can display/reproduce this received data.

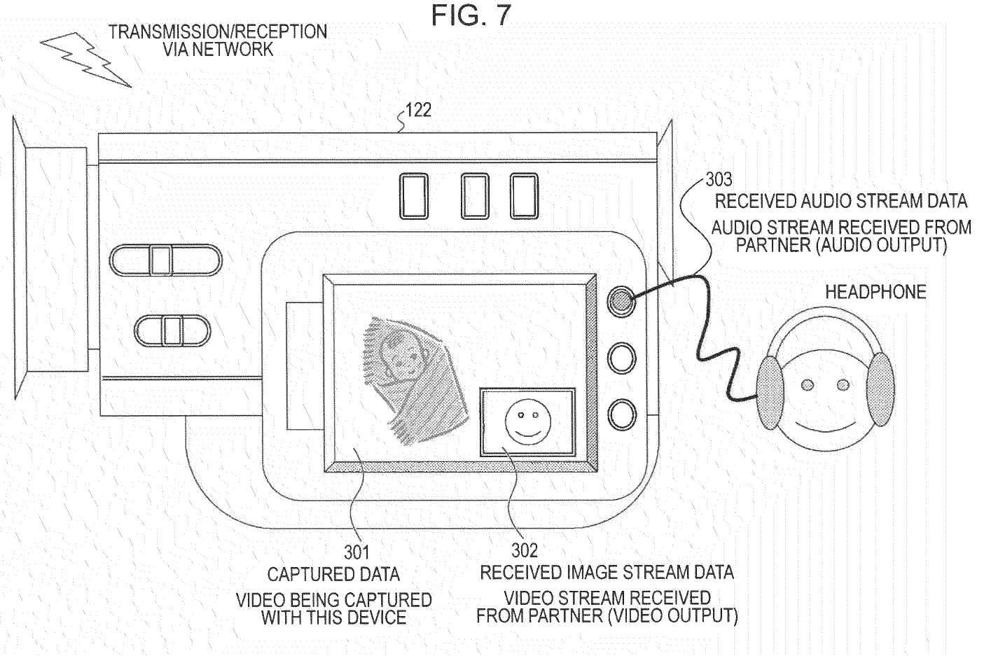

An example of a configuration of processing for reproducing received data in the video camera A 122 will be described with reference to FIG. 7. As a method for displaying video received from the reception box B 143, the video can be displayed, for example, by outputting a small screen at a lower right corner of a liquid crystal screen of the video camera A 122 as shown in FIG. 7. As shown in FIG. 7, captured data 301, which is video being captured, is displayed, and a screen area displaying video received from the reception box B 143 is set and received image stream data 302 is also displayed on the liquid crystal screen of the video camera A 122. Meanwhile, another liquid crystal screen different from the display screen of the captured data may be employed to display the received image stream data 302.

Additionally, as a method for reproducing audio from the reception box B 143, for example, audio may be output from an audio output port of the video camera A 122 and the user A may listen to the audio, namely, received audio stream data 303, with a headphone or the like. Meanwhile, when the video camera A 122 is in the “capturing mode”, only audio of a partner has to output from the headphone since ambient sound can be heard. However, since the audio being reproduced as well as the audio of the partner have to simultaneously reproduced in the “reproduction mode”, it is configured that control such as mixing the audios or separating the audios so that one of them are output from a speaker of the video camera A 122 and the other is output from the headphone is performed. These permit interactive communication.

### 6. Regarding Preceding Setting Processing

As described before in [4. Processing of Router and Packet transmission/Reception Processing],

at the time of the packet transmission from the video camera A 122 to the reception box B 143, these kinds of preceding processing of

(a) the video camera A 122's learning an IP address of the router B 142 and

(b) the router B 142's making a setting for transferring an IP packet to the reception box B 143

are needed.

In addition, when data transmission is performed from the reception box B 143 to the video camera A 122, these kinds of processing of

(c) the reception box B 143's learning an IP address of the router A 123 and

(d) the router A 123's making a setting for transferring an IP packet to the video camera 122

are needed.

These kinds of processing will be described below. Since only processing executing entities differ between the processing of (a) and (c) and between the processing of (b) and (d) and the processing itself is similar, processing necessary at the time of the packet transmission from the video camera A 122 to the reception box B 143, namely, these kinds of processing of

(a) the video camera A 122's learning an IP address of the router B 142 and

(b) the router B 142's making a setting for transferring an IP packet to the reception box B 143

will be described.

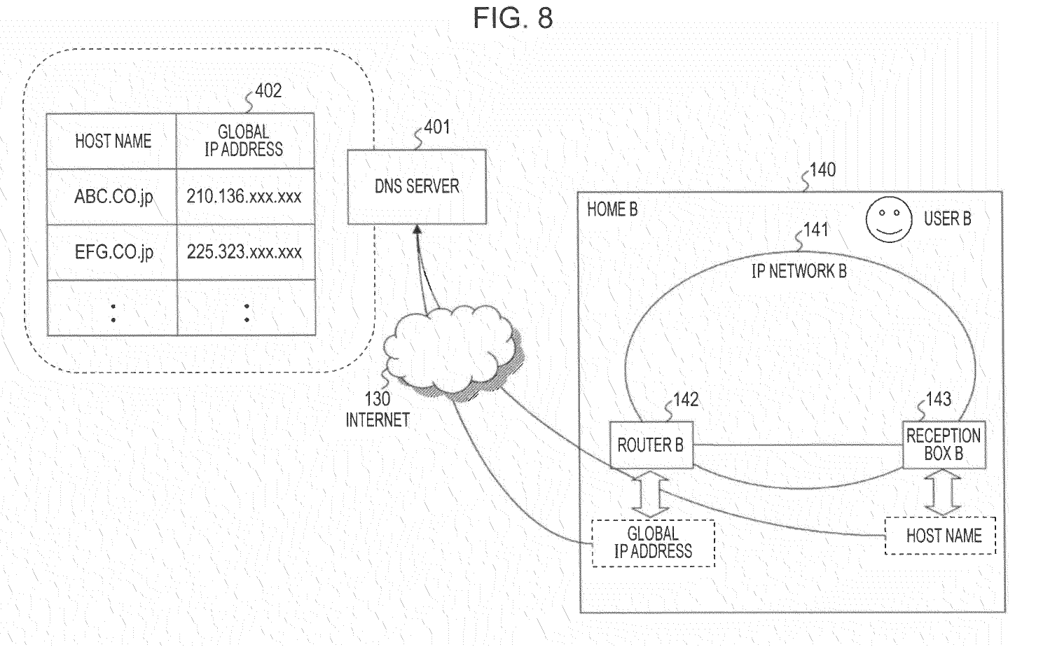

First, this processing (a) of the video camera A 122's learning the IP address of the router B 142 will be described with reference to FIG. 8. In order for the video camera A 122 to learn the global address of the router B, a DNS (Domain Name Service) is utilized.

Processing for utilizing the DNS will be described with reference to FIG. 8. A DNS server 401 shown in FIG. 8 holds, as a database, a host-name IP-address correspondence table 402, which is a correspondence table of a host name and an IP address. Upon receiving an address inquiry specifying a host name from a network connection device, the DNS server 401 performs retrieval in the table 402, acquires an IP address registered in association with a host life, and notifies the device having made the inquiry of the IP address. With this, an IP address of a target device can be acquired utilizing a host name (such as www.sony.co.jp), which is more easily understood by a human, even if the human does not remember the IP address, and access and packet transmission to a target host utilizing the IP address becomes possible. By setting the acquired IP address as a destination address of a transmission packet, data transmission to the target host becomes possible.

Generally, for example, a global IP address 402 of the router B 143 located at an entrance of a home network is often not assigned in a fixed manner. For example, a DHCP server dynamically sets the IP address. In a configuration where the fixed address is not set and the IP address is dynamically set in this manner, the dynamically set IP address is acquired using a dynamic DNS. The Dynamic DNS is a service for dynamically updating a database managed by the DNS server by notifying the DNS server of a currently set IP address each time.

The reception box B 143 shown in FIG. 8 has a dynamic DNS global IP address notifying function. When an IP address is dynamically set by the DHCP server at the time of booting of the reception box B 143, the DNS server 401 is notified of the host name of the reception box B 143 and the global IP address of the router B 142.

Even if the global IP address of the router B 142 is not fixed, the video camera A 122 can acquire the global IP address of the router B 142 from the DNS server 401 using the DNS mechanism as long as the video camera A knows the host name of the reception box B 143.

More specifically, the video camera A 122 transmits an address inquiry based on the host name of the reception box B 143 to the DNS server 401 and can acquire, from the DNS server 401, the global IP address of the router B 142 as an address registered in the table 402 in association with the host name of the reception box B 143. The video camera A generates an IP packet in which this acquired global IP address of the router B 142 is set as a destination address and outputs the packet to a network.

This processing is

solution processing of

(a) the video camera A 122's learning an IP address of the router B 142.

Next, this processing of

(b) the router B 142's making a setting for transferring an IP packet to the reception box B 143

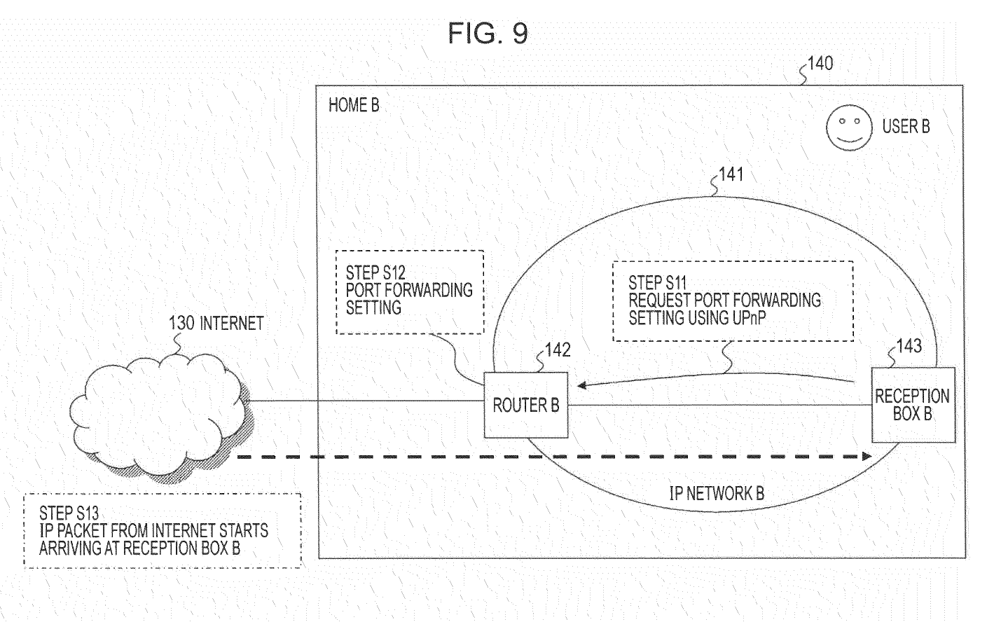

will be described with reference to FIG. 9. Even if the video camera A 122 has learned the global IP address of the router B 142 from the above-described DNS server, and generates and outputs a message packet for signaling or an actual stream data packet after setting the global IP address of the router B, the router B 142 generally has a firewall function and discards the IP packet.

More specifically, when an appropriate port forwarding setting is not made in the router B 142, the packet is not transferred to the reception box B 143. Of course, a user may manually perform the port forwarding setting in the router, which may be unpreferable since the setting is complicated or an incorrect setting creates a security hole.

Accordingly, in this embodiment, the port forwarding setting is dynamically performed in the router B 142 using a UPnP (Universal Plug and Play) mechanism. In the UPnP, a mechanism capable of performing the port forwarding setting of the router is provided. For example, a setting of

“transferring packets having arrived at a TCP port number 80 of the router from the Internet to a TCP port number 10080 of a PC located in an internal network”

can be made by transmitting a UPnP message from the PC to the router. Meanwhile, most of recent broadband router products support the UPnP.

The reception box B 143 has a function for performing the above-described UPnP port forwarding setting. The reception box B 143 automatically sets a port for signaling messages at a predetermined timing, e.g., at the time of power-on. More specifically, the reception box B transmits, to the router B 142, a UPnP message for the setting of “transferring packets having arrived at a TCP port number xx of the router B 142 from the Internet to a TCP port number aaa of the reception box 143 located in an internal network (the IP network B 141)”.

In addition, when the port for signaling is separated from a port for stream data, it may be configured that the port for the signaling and the port for stream data are separately set by sending a UPnP message for setting the port for stream data from the reception box B 143 to the router B 142 after establishment of the signaling. The port forwarding setting may be configured to be made with a method considering security while appropriately changing dynamically.

As long as the name (URL) of the reception box B 143 side and the signaling port number are known previously, the video camera A 122 can certainly transmit a signaling message to the reception box B 143 through the router B. An IP packet transmitted from the router B 142 is set to be directed to a port number to which the port forwarding is set. The router B 142 transmits packets having arrived at this port number to the reception box B 143 in accordance with the port forwarding setting.

As described above, in order for the video camera A 122 to surely perform data transmission to the reception box B 143, these kinds of information of

(1) a host name (URL) of the reception box B 143 side and

(2) a port number for signaling to be set in the router B

have to be acquired previously. As a method for acquiring this information, for example, authentication processing between the video camera A 122 and the reception box B 143 can be employed.

For example, on condition that the reception box B 143 has confirmed the video camera A 122 to be a valid device by executing authentication processing between both devices, namely, the video camera A 122 and the reception box B 143,

(1) the host name (URL) of the reception box B 143 side and

(2) the port number for signaling to be set in the router B

are transmitted from the reception box B 143 to the video camera A 122. The video camera A 122 is configured to record and hold these kinds of information in a memory.

As a method of the authentication processing, the authentication processing is executed using mutual near field communication. More specifically, for example, a “simple authentication” button is set in both devices of the video camera A 122 and the reception box B 143 and the near radio communication is performed by pressing the “simple authentication” button at the same time with these two devices being brought closer. On condition of establishment of authentication after execution of the authentication processing via this near radio communication, the above-described kinds of information (1) and (2) are provided to the video camera A 122 from the reception box B 143.

Alternatively, it may be configured that a document including these kinds of information of a URL (host name) thereof and a port number, namely,

(1) a host name (URL) of the reception box and

(2) a port number for signaling to be set in the router

is enclosed in the reception box B 143 sold as a product and a user performs processing for recording these kinds of information in a memory of the video camera utilized by the user at the time of purchase of the device.

Alternatively, it may be configured that a user on the reception box side may inform a user of the video camera A 122 of these kinds of information of

(1) a host name (URL) of the reception box and

(2) a port number for signaling to be set in the router and

the user of the video camera A 122 manually sets them in the video camera A 122.

In this manner, these kinds of information of

(1) the host name (URL) of the reception box and

(2) the port number for signaling to be set in the router

are provided to a data transmitting side device (the video camera in this embodiment) from a data receiving side device (the reception box in this embodiment) side. The data transmitting side device (the video camera in this embodiment) holds these kinds of information and performs processing utilizing these kinds of information, whereby the data transmitting side device (the video camera in this embodiment) can certainly execute data transmission to the data reception side device (the reception box in this embodiment).

More specifically, as described with reference to FIG. 8, the data transmitting side device (the video camera in this embodiment) acquires a global IP address of the router B 142 from a DNS server utilizing this information of

(1) the host name (URL) of the reception box B 143, generates an IP packet in which these kinds of information of the above-described information (2) provided from the reception box 143 side, namely,

(2) the port number for signaling to be set in the router

in addition to this global IP address, i.e., an IP packet in which the global IP address of the router B 142 and the port number are specified as a destination, and outputs the IP packet to a network, whereby the IP packet is delivered to the router B 142. Furthermore, the IP packet is transferred to the reception box B 143 from the router 142 by the port forwarding and the reception box B 143 can receive the transmission packet from the video camera A 122.

As described above, the data transmitting side device (the video camera in this embodiment) is configured to receive these kinds of information of

(1) a host name (URL) of a reception box and

(2) a port number for signaling to be set in a router

from the data receiving side device (the reception box in this embodiment) side and to generate and transmit a packet employing these kinds of information, thereby being able to perform data transmission to a particular receiving device.

Meanwhile, although the description given above is a description regarding a setting for realizing data transmission to the reception box 143 from the video camera A 122 in the configuration shown in FIG. 5, opposite-direction data transmission from the reception box B 143 to the video camera A 122 can be handled by performing processing similar to the above-described one on the opposite-direction route. However, when the reception box B 143 side receives a transmission packet from the video camera 122, since the reception box B can acquire a transmission source address recorded in the transmission packet, processing for acquiring an address from the DNS server is unnecessary. Only a port forwarding setting on the router A 123 side has to be performed. These kinds of processing permit communication between both items.

### 7. Overall Processing Flow

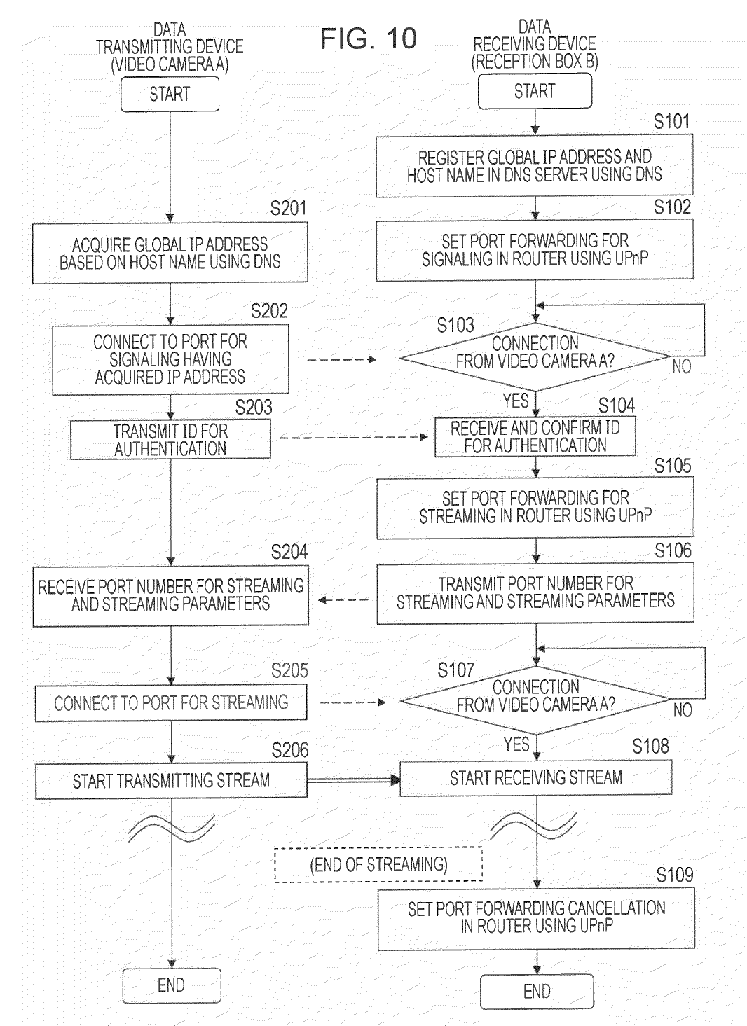

Next, a flow of overall processing of the above-described setting processing for performing communication and communication execution processing will be described with reference to a flowchart shown in FIG. 10.

In FIG. 10, processing sequences of processing of a data transmitting device (the video camera in this embodiment) and a data receiving device (the reception box in this embodiment) are shown on the left side, respectively. Each processing step will be described. Meanwhile, the processing flow shown in FIG. 10 is processing after the data transmitting device (the video camera) has received these kinds of information of

(1) the host name (URL) of the reception box and

(2) the port number for signaling to be set in the router

from the data receiving device (the reception box) side.

First, at STEP S101, the data receiving device (the reception box in this embodiment) registers a global IP address of a router serving as a network relay device and a host name of the data receiving device (the reception box) in a DNS server. This processing is the processing described with reference to FIG. 8, and correspondence data between the global IP address of the router and the host name of the reception box is registered in the DNS server.

Next, at STEP S102, the data receiving side device performs a port forwarding setting for signaling in a router using the UPnP. This processing is the processing described with reference to FIG. 9 before. As described with reference to FIG. 9, the reception box B 143 has a function for performing the UPnP port forwarding setting and transmits, to the router B 142, a UPnP message for a setting of “transferring packets having arrived at a TCP port number xx of the router B 142 from the Internet to a TCP port number aaa of the reception box 143 located in an internal network (the IP network B 141)”. The router B 142 executes the port forwarding setting in accordance with this message.

Referring back to FIG. 10, the description is continued. After finishing the processing of STEPs S101 and S102, the data transmitting device (the video camera) executes an IP address inquiry based on the host name of the data receiving device (the reception box) to the DNS server, at STEP S201, to acquire the global IP address of the relay device (the router B).

Next, at STEP S202, on the basis of the global IP address of the relay device (the router B) acquired at STEP S201 and “the port number for signaling to be set in the router” provided from the data receiving device (the reception box), the data transmitting device transmits a signaling message after setting these IP address and port number as a destination.

This signaling message is delivered to the relay device (the router B) on the data receiving device (the reception box) side. The relay device (the router B) transfers this signaling message to the data receiving device (the reception box) in accordance with the previously set port forwarding setting.

At STEP S103, the data receiving device (the reception box) receives the message and confirms whether the received message is a message from a specific data transmitting device (the video camera) on the basis of a transmission source address. If it is determined that the received message is the message from the specific data transmitting device (the video camera), the data receiving device waits for reception of an IP for use in authentication.

At STEP S203, the data transmitting device (the video camera) transmits the authentication ID to the data receiving device (the reception box). At STEP S104, the data receiving device (the reception box) receives this ID and executes verification with a previously registered ID to confirm that the data transmitting device is the specific data transmitting device (the video camera).

Next, at STEP S105, the data receiving device (the reception box) transmits a UPnP message for setting a port for stream data to the relay device (the router B) in accordance with the UPnP to set the port for stream data. Meanwhile, this flow is an example of separately setting the port for stream data and the port for signaling messages.

Next, at STEP S106, the data receiving device (the reception box) transmits, to the data transmitting device (the video camera), the port number for the stream data and parameters for transmission of the stream data, e.g., parameters such as a bit rate and encode information. Meanwhile, when the port for the stream data and the port for the signaling message are the same, the processing of STEP S105 can be omitted and the port number for the stream data does not have to be transmitted at STEP S106.

Upon receiving the port number for the stream data and the parameters for stream data transmission from the data receiving device (the reception box) at STEP S204, the data transmitting device (the video camera) establishes a connection to the port for the stream data at STEP S205 and starts transmitting a stream at STEP S206. In a packet containing stream data, the IP address of the relay device (the router B) on the data receiving device (the reception box) side and the port to which the port forwarding directed to the data receiving device (the reception box) is set are specified.

At STEP S107, the data receiving device (the reception box) confirms that the data is data forwarded from a stream data distribution port. At STEP S108, the data receiving device receives the stream data transmitted from the data transmitting device (the video camera). Thereafter, if the transmission of the stream data from the data transmitting device (the video camera) is terminated, the data receiving device (the reception box) outputs, to the relay device (the router B), a message requesting processing for canceling the port forwarding according to the UPnP. The relay device (the router B) having received this message cancels the port forwarding setting directed to the data receiving device (the reception box).

Through the above-described processing, stream data transmitted from the data transmitting device (the video camera) is certainly transmitted to the data receiving device (the reception box) through the relay device (the router B) on the data receiving device (the reception box) side. For example, data being captured in the data transmitting device (the video camera) can be output on output means on the data receiving device (the reception box) side and viewed like a live broadcast.

### 8. Example of Apparatus Configuration

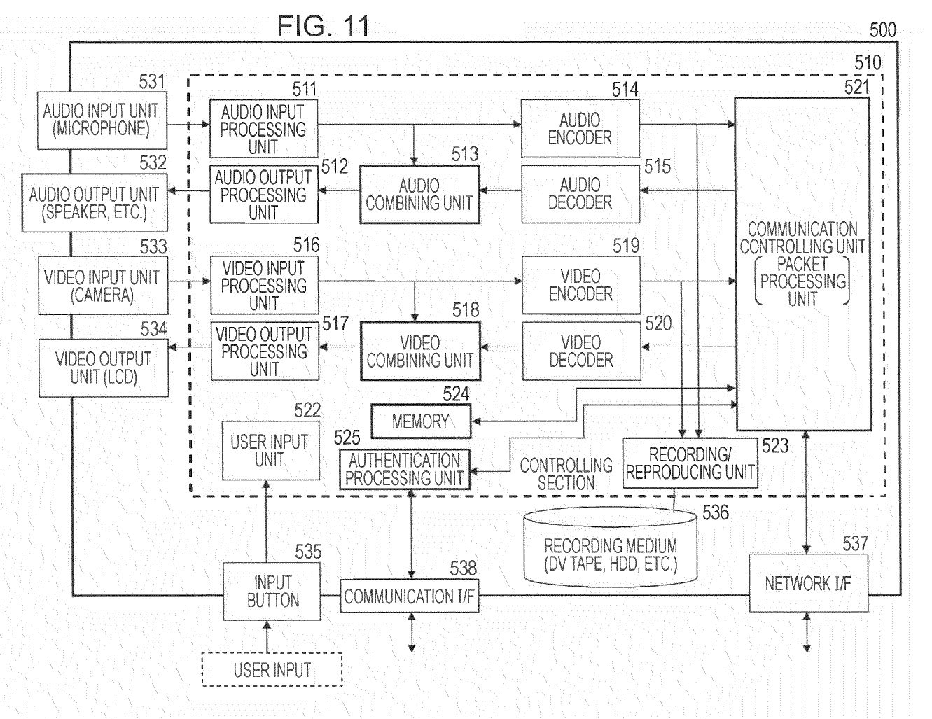

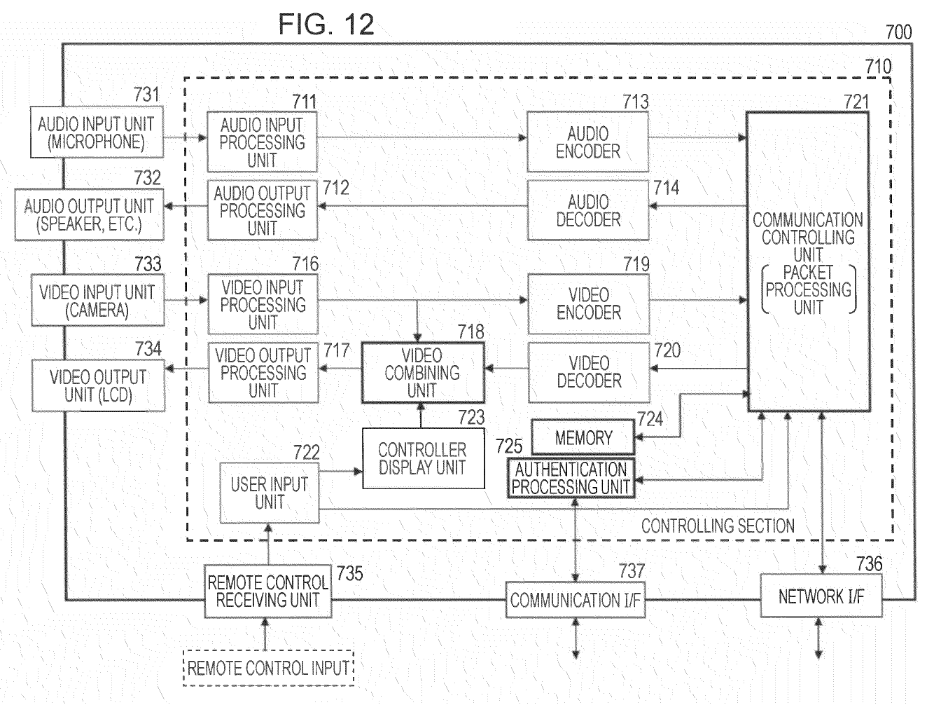

Lastly, configurations of information processing apparatuses of the present invention will be described with reference to FIG. 11 and FIG. 12. FIG. 11 is a diagram showing an example of a configuration of a video camera serving as an example of the data transmitting device, whereas FIG. 12 is a diagram showing an example of a configuration of a reception box serving as an example of the data reception device. Meanwhile, the reception box shown in FIG. 12 is an example of a configuration in which the reception box is integrated into the output means. In addition, the video camera shown in FIG. 11 is a device having a configuration capable of executing data reception processing and output of the received data as well. The reception box shown in FIG. 12 includes a camera and a microphone, and has a configuration capable of executing processing for outputting captured video and audio to a network.

First, a configuration of a video camera 500 will be described with reference to FIG. 11. At the time of capturing processing, the video camera 500 receives audio from an audio input unit (microphone) 531 and receives video from a video input unit (camera) 533, executes encoding processing on the respective input data in an audio encoder 514 and a video encoder 519 of a controlling section 510, and records the data on a recording medium 536, such as a DV tape, a hard disk, or a DVD, through a recording/reproducing unit 523.

In addition, at the time of reproduction processing of data recorded on the recording medium 536, the recording/reproducing unit 523 acquires encoded audio and video data from the recording medium 536, executes decoding processing in an audio decoder 515 and a video decoder 520, respectively. The audio data is output through an audio output unit 512, such as a speaker, through an audio output processing unit 512, whereas the video data is output through a video output unit 534, such as an LCD, through a video output processing unit 517.

These kinds of processing are executed under the control of the controlling section 510 in accordance with request types of a start of capturing and a start of reproduction input by a user. A user input unit 522 of the controlling section 510 detects the user input through an input button 535. The processing described above is processing similar to that of existing video cameras.

Data transmission processing, which is one of features of the present invention, will be described. For example, when captured data is transmitted, a communication controlling unit (a packet processing unit) 521 receives encoded audio data generated by the audio encoder 514 and encoded video data generated by the video encoder 519, generates a packet containing these kinds of encoded data, and outputs the packet through a network I/F 537.

As described in the embodiments given above, information specifying an IP address of a router set as a relay device of a local network of a receiving device and a port number to which port forwarding directed to the receiving device is set is employed as destination information set in this transmission packet. These kinds of information are stored in a memory 524. The communication controlling unit (the packet processing unit) 521 acquires these kinds of information from the memory 524, generates a transmission packet, and outputs the packet through the network I/F 537.

Meanwhile, it is also possible to transmit reproduced data in synchronization with reproduction processing of data recorded on the recording medium 536, for example. In this case, the recording/reproducing unit 523 acquires encoded audio and video data from the recording medium 536. Decoding processing is executed on the encoded audio and video data in the audio decoder 515 and the video decoder 520, respectively. The recording/reproducing unit 523 also inputs the encoded audio and video data acquired from the recording medium 536 to the communication controlling unit (the packet processing unit) 521. The communication controlling unit (the packet processing unit) 521 generates a packet containing these kinds of input data and outputs the packet through the network I/F 537. The destination setting is made on the basis of the address and port number acquired from the memory 524 in the same manner as the above-described processing.

In addition, when reproduction processing regarding data received through the network I/F 537 is executed, the communication controlling unit (the packet processing unit) 521 executes analysis of the packet received through the network I/F 537 to execute discrimination of audio data from video data, input respective data to the audio decoder 515 and the video decoder 520 to execute decoding processing. The audio data is output through the audio output unit 512, such as a speaker, through the audio output processing unit 512, whereas the video data is output through the video output unit 534, such as an LCD, through the video output processing unit 517.

Meanwhile, when reproduction of captured data is also executed at the time of this reproduction processing, reproduction of the received data and reproduction of the captured data have to be executed in parallel. As described before with reference to FIG. 7, the processing of this case is executed as reproduction processing that permits each kind of data to be discriminated. For example, as described with reference to FIG. 7, it is set that the received video data is output on a part of an LCD screen and the audio is output to a headphone. These kinds of output controlling processing are executed as processing of an audio combining unit 513 and a video combining unit 518 shown in FIG. 11.

In this manner, the communication controlling unit (the packet processing unit) 512 executes processing for generating a transmission packet containing data captured in the video camera and outputting the packet to a network. At this time, the communication controlling unit executes the processing for generating a transmission packet containing the received address and the port number as destination information and outputting the packet to a network after acquiring a host name of a data transmission destination device and a port number to which port forwarding processing of a relay device of a network connected to the data transmission destination device is set and receiving address information corresponding to the host name of the data transmission destination device from a DNS server.

Additionally, an authentication processing unit 525 shown in the drawing executes authentication processing with the data transmission destination device through a communication I/F 538. On condition of establishment of authentication in the authentication processing unit 525, the host name of the data transmission destination device and a port number to which the port forwarding processing of the relay device of a network connected to the data transmission destination device is set are received from the data transmission destination device and are stored in the memory 524.

Next, an example of a configuration of the reception box serving as an example of the data receiving device will be described with reference to FIG. 12. The reception box shown in FIG. 12 has functions of communication means and reception data output means. Furthermore, the reception box not only outputs data received via a network but also includes a camera and a microphone and has a configuration capable of executing processing for outputting captured video and audio to a network.

When a reception box 700 executes reproduction processing regarding data received through a network I/F 736, a communication controlling unit (a packet processing unit) 721 executes analysis of a packet received through the network I/F 736 to execute discrimination of audio data from video data, and inputs the respective data to an audio decoder 714 and a video decoder 720 to execute decoding processing. The audio data is output through an audio output unit 732, such as a speaker, through an audio output processing unit 712, whereas the video data is output through a video output unit 734, such as an LCD, through a video output processing unit 717.

Furthermore, the reception box shown in FIG. 12 includes a video input unit 733, such as a camera, and an audio input unit 731, such as a microphone, and executes processing for outputting captured video and audio to a network. When this processing is performed, the data output to the network is also output to the video output unit 734 of this device. For example, as described before with reference to FIG. 6, output of data acquired by this device is also executed in addition to reproduction of received data. The processing of this case will be described with reference to a configuration diagram shown in FIG. 12.

The reception box 700 receives audio from the audio input unit (microphone) 731 and receives video from the video input unit (camera) 733, executes encoding processing of respective input data in an audio encoder 714 and a video encoder 719 of a controlling section 710, and inputs the encoded data to the communication controlling unit (the packet processing unit) 721. The communication controlling unit (the packet processing unit) 721 receives the encoded audio data generated by the audio encoder 714 and the encoded video data generated by the video encoder 719, generates a packet containing these kinds of encoded data, and outputs the packet through the network I/F 736.

Information specifying an IP address of a router set as a relay device of a local network connected to the video camera and a port number to which port forwarding setting directed to a receiving device is made can be employed as destination information set in this transmission packet. These kinds of information are stored in a memory 724. The communication controlling unit (the packet processing unit) 721 acquires these kinds of information from the memory 724, generates a transmission packet, and outputs the packet through the network I/F 736.

Meanwhile, when output of images captured with the video input unit 733 of this device is performed at the time of the reproduction processing of the received data, the processing is executed as output processing in which each data can be discriminated as described before with reference to FIG. 6. For example, as described with reference to FIG. 6, the received video data is mainly output, whereas images captured with the video input unit 733 of this device are output at a part of a screen serving as a sub screen. These kinds of output controlling processing are executed as processing of a video combining unit 718 shown in FIG. 12.

Meanwhile, instructions for data reception, data reproduction, and so forth can be input with, for example, a remote control. A remote control receiving unit 735 receives user's remote control operation information. The reception signal of the remote control receiving unit is analyzed in a user input unit 722. For example, if the user input indicates a processing for changing a display format, a controller display unit 723 is supplied with the user request and controls the video combining unit 718 to perform a change in the display format.

Furthermore, as described before with reference to FIG. 3 and FIG. 6, a user can perform a setting of a bit rate of received data, a setting of executing or terminating transmission of data captured with this device, and so forth. These settings are also processable with the remote control. The user input unit analyzes a user request received by the remote control receiving unit 735 and, if the request is a request regarding data transmission/reception processing, request information is output to the communication controlling unit (the packet processing unit) 721.

For example, if the request is a user request for terminating or starting of data transmission or the like, processing for terminating or starting transmission of captured data of this device is performed in accordance with the request. In addition, if the user request is a request for changing a bit rate of received data or the like, processing for generating and transmitting a message packet containing a requested bit rate or the like is executed.

Additionally, the communication controlling unit 721 performs execution and termination of transmission of a packet containing the data captured in the video input unit (the camera) 733 on the basis of the input information input through the user input unit 722. In addition, the data combining unit 718 displays and outputs the bit rate information of the data received in the communication controlling unit. The communication controlling unit 721 executes processing for outputting, to a transmission source of the data received via a network, a bit rate setting request on the basis of the bit rate setting information input through the user input unit 722.

Additionally, an authentication processing unit 725 shown in the drawing executes authentication processing with a data transmission source device through a communication I/F 737. For example, on condition of establishment of authentication in the authentication processing unit 725, reception of stream data from the data transmission source device is started.

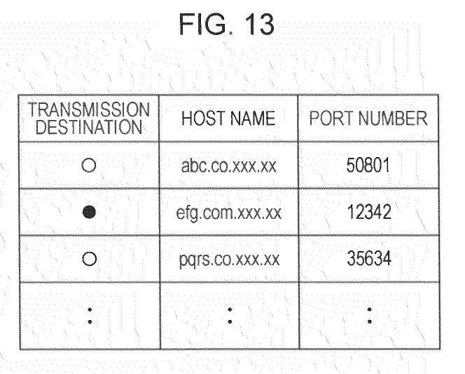

Meanwhile, the description has been given for a setting example in which the data transmitting device (the video camera) stores one host name and one port number in a memory of the data transmitting device (the video camera) as the setting for transmitting data to one data receiving device. However, for example, as shown in FIG. 13, it may be set that host names for a plurality of data transmission destinations and port numbers serving as port forwarding setting information of a relay device (a router) set in networks connected to the respective hosts are stored in the memory of the data transmitting device (the video camera) and a user can select one or more transmission destinations. It may be configured that this selection information is input to the communication controlling unit 521 of the video camera shown in FIG. 11, addresses corresponding to the selected host names are acquired from a DNS server, a packet, in which the addresses and port numbers corresponding to these plurality of hosts are set, is transmitted. According to this configuration, it is possible to perform data transmission after selecting a given transmission destination from various transmission destinations and also simultaneously transmit captured data of the video camera to a plurality of specific devices.

The present invention has been described in detail above with reference to the specific embodiments. However, it is obvious that those skilled in the art can make modifications and substitutions of the embodiments within a scope not departing from the spirit of the present invention. That is, the present invention has been disclosed in an illustrative manner and should not be limitedly interpreted. To determine the spirit of the present invention, Claims should be considered.

In addition, a series of processing described in the specification can be executed by hardware, software, or a combination of the both. When processing by software is executed, a program recording a processing sequence can be installed in a memory included in a computer embedded in dedicated hardware and executed or the program can be installed in a general-purpose computer capable executing various kinds of processing and executed.

For example, the program can be previously recorded on a hard disk or a ROM (Read Only Memory) serving as a recording medium. Alternatively, the program can be temporarily or permanently stored (recorded) on removable recording media, such as a flexible disk, a CD-ROM (Compact Disc Read Only Memory), an MO (Magneto optical) disk, a DVD (Digital Versatile Disc), a magnetic disk, and a semiconductor memory. Such removable media can be provided as so-called package software.

Meanwhile, in addition to installment of the program into a computer from the above-described removable recording media, the program can be wirelessly transferred to the computer from a download site or transferred to the computer with a cable via a network, such as a LAN (Local Area Network) or the Internet, and the computer can receive the program transferred in that manner and install the program in a recording medium, such as a hard disk, included therein.

In addition, various kinds of processing described in the specification may be not only executed chronologically in accordance with the description but also executed in parallel or individually in accordance with a processing capability of an apparatus executing the processing or needs. Additionally, in this specification, a system is a configuration of a logical collection of a plurality of apparatuses and is not limited to one including apparatuses of respective configurations in an identical housing.

### INDUSTRIAL APPLICABILITY

As described above, according to a configuration of one embodiment of the present invention, for example, in a configuration for generating a transmission packet containing captured data of a video camera and outputting the transmission packet to a network, it is configured that a host name of a data transmission destination device and a port number, to which port forwarding processing of a relay device of a network connected to the data transmission destination device is set, are acquired from a memory, address information corresponding to the host name of the data transmission destination device is acquired from a DNS server, and a transmission packet containing data captured in a video camera is output to a network after the address information and the port number are set in the transmission packet as destination information. This permits data to be certainly transmitted to a specific selected device and reproduction of stream data, serving reproduction of data in synchronization with a timing of capturing, is realized.

1. A communication processing apparatus having a video camera function, characterized by comprising:
a communication controlling unit that executes processing for generating a transmission packet containing data captured with the video camera function and for outputting the transmission packet to a network; and
a memory that stores a host name of a data transmission destination device and a port number to which port forwarding processing, of a relay device of a network connected to the data transmission destination device, for transferring the transmission packet to the data transmission destination device is set, wherein
the communication controlling unit
is configured to execute the processing for generating the transmission packet including, as destination information, the port number and address information corresponding to the host name of the data transmission destination device and for outputting the transmission packet to the network.

2. The communication processing apparatus according to claim 1, characterized in that the communication controlling unit
is configured to receive, from a DNS server, the address information corresponding to the host name of the data transmission destination device stored in the memory, and to execute the processing for generating the transmission packet including, as the destination information, the received address and for outputting the transmission packet to the network.

3. The communication processing apparatus according to claim 1, the communication processing apparatus characterized by comprising:
an authentication processing unit that executes authentication processing with the data transmission destination device, wherein
it is configured that processing for receiving, on condition of establishment of authentication in the authentication processing unit, the host name of the data transmission destination device and the port number to which the port forwarding processing of the relay device of the network connected to the data transmission destination device is set from the data transmission destination device and for storing the host name and the port number in the memory is executed.

4. The communication processing apparatus according to claim 1, the communication processing apparatus characterized by further comprising:
a decoder that executes decoding processing of image and audio data included in reception data of the communication controlling unit; and
a data combining unit that performs control for combining data generated by the decoder with the data captured with the video camera function.

5. A communication processing apparatus that executes output control of data received via a network,
the communication processing apparatus characterized by comprising:
a communication controlling unit that executes a request for setting port forwarding processing, which is processing for transferring packets to the communication processing apparatus, to a relay device of a network connected to the communication processing apparatus, and receives data via the network and the relay device;
a decoding processing unit that executes decoding processing of the data received at the communication processing unit; and
an output processing unit that executes processing for outputting data generated in the decoding processing unit.

6. The communication processing apparatus according to claim 5, the communication processing apparatus characterized by further comprising:
a camera unit; and
a data combining unit that performs control for combining the data received at the communication controlling unit with data captured in the camera.

7. The communication processing apparatus according to claim 6, characterized in that the communication controlling unit
is configured to execute processing for generating a packet containing data captured in the camera and for outputting the packet to the network.

8. The communication processing apparatus according to claim 7, characterized in that the communication controlling unit
is configured to perform execution and termination of transmission of the packet containing the data captured in the camera on the basis of input information input through a user input unit.

9. The communication processing apparatus according to claim 5, the communication processing apparatus characterized by comprising:
a data combining unit that displays and outputs bit rate information of the data received at the communication controlling unit.

10. The communication processing apparatus according to claim 9, characterized in that the communication controlling unit
is configured to execute processing for outputting a bit rate setting request to a transmission source of the data received via the network on the basis of bit rate setting information input through a user input unit.

11. A data communication system including data transmitting means having a video camera function; and data receiving means for receiving transmission data of the data transmitting means, the data communication system characterized in that
the data transmitting means includes:
a communication controlling unit that executes processing for generating a transmission packet containing data captured with the video camera function and for outputting the transmission packet to a network; and
a memory that stores a host name of the data receiving means and a port number to which port forwarding processing, of a relay device of a network connected to the data receiving means, for transferring the transmission packet to the data receiving means is set, and wherein
the communication controlling unit
is configured to execute the processing for generating the transmission packet including, as destination information, the port number and address information corresponding to the host name of the data receiving means and for outputting the transmission packet to the network, and wherein
the data receiving means includes:
a communication controlling unit that executes a request for setting the port forwarding processing to the relay device of the network connected to the data receiving means and receives data from the data transmitting means via the network and the relay device;
a decoding processing unit that executes decoding processing of the data received at the communication controlling unit from the data transmitting means; and
an output processing unit that executes output processing of data generated in the decoding processing unit.

12. A communication controlling method in a communication processing apparatus having a video camera function,
the communication controlling method characterized by comprising:
a step of a communication controlling unit's acquiring, from a memory, a host name of a data transmission destination device and a port number to which port forwarding processing, which is processing for transferring packets to the data transmission destination device, of a relay device of a network connected to the data transmission destination device is set;
a step of the communication controlling unit's receiving address information corresponding to the host name of the data transmission destination device from a DNS server; and
a step of the communication controlling unit's executing processing for generating a transmission packet that includes, as destination information, the port number and the address information corresponding to the host name of the data transmission destination device and that contains data captured with a video camera and for outputting the transmission packet to a network.

13. A data processing method for executing control of data received via a network in a communication processing apparatus,
the data processing method characterized by comprising:
a step of a communication controlling unit's executing a request for setting port forwarding processing, serving as processing for transferring packets to the communication processing apparatus, to a relay device of a network connected to the communication processing apparatus;
a step of the communication controlling unit's receiving data via the network and the relay device;
a decoding processing step of a decoding processing unit's executing decoding processing of the data received at the communication controlling unit; and
an output processing step of an output processing unit's executing output processing of data generated in the decoding processing unit.

14. A computer program allowing a communication processing apparatus having a video camera function to execute communication control,
the computer program characterized by comprising:
a step of allowing a communication controlling unit to acquire, from a memory, a host name of a data transmission destination device and a port number to which port forwarding processing, which is processing for transferring packets to the data transmission destination device, of a relay device of a network connected to the data transmission destination device is set;
a step of allowing the communication controlling unit to receive address information corresponding to the host name of the data transmission destination device from a DNS server; and
a step of allowing the communication controlling unit to execute processing for generating a transmission packet that includes, as destination information, the port number and the address information corresponding to the host name of the data transmission destination device and that contains data captured with a video camera and for outputting the transmission packet to a network.

15. A computer program for allowing a communication processing apparatus to control data received via a network,
the computer program characterized by comprising:
a step of allowing a communication controlling unit to execute a request for setting port forwarding processing, serving as processing for transferring packets to the communication processing apparatus, to a relay device of a network connected to the communication processing apparatus;
a step of allowing the communication controlling unit to receive data via the network and the relay device;
a decoding processing step of allowing a decoding processing unit to execute decoding processing of the data received at the communication controlling unit; and
an output processing step of allowing an output processing unit to execute output processing of data generated in the decoding processing unit.
